(19) United States
(12) Patent Application Publication
(10) Pub. No.: US 2014/0081427 A1
(43) Pub. Date: Mar. 20, 2014

(54) TUNING METHODS OF THE PI AND PID CONTROLLERS PARAMETERS

(71) Applicants: Miroslaw Wcislik, Kielce (PL); Michal Laskawski, Kielce (PL)

(72) Inventors: Miroslaw Wcislik, Kielce (PL); Michal Laskawski, Kielce (PL)

(73) Assignee: POLITECHNIKA SWIETOKRZYSKA, KIELCE (PL)

(21) Appl. No.: 14/123,013

(22) PCT Filed: May 28, 2012
(86) PCT No.: PCT/PL2012/000036

§ 371 Date: Nov. 27, 2013

(30) Foreign Application Priority Data
May 27, 2011 (PL) PL395033

(51) Int. Cl. G05B 11/01

(52) U.S. Cl. CPC G05B 11/01
USPC 700/52

(57) ABSTRACT

The invented controller tuning method relies on the following procedure. To the controlled system with known proportional gain the integral type controller is connected in series. The controller gain kₗ is increased to get the closed loop system to the stability limit. At this stage the controller ultimate gain kᵤ and the sustained oscillation period period T_{osc} of the controlled value are assessed. It is assumed that the controlled system dynamics can be approximated by the first order filter with dead time model. The following formulas allow to estimate the first order filter time constant F(1) and the coefficient θ=L/T=(arcctg(ω_{osc}T))/(ω_{osc}T) where L is the dead time constant of the controlled system model. From the formulas: F(2) the controller model parameters are calculated. After that on the basis of the calculated controller model parameters value the real controller parameters are calculated from the formulas: F (3) the proportional controller gain, the T_{iN} is the integral controller time constant and the T_{dN} is the derivative controller time constant.

The subject of the invention is the tuning method of PI and PID controllers parameters.

There are a lot of well-known tuning methods of the PI and PID controllers parameters collected by O'Dwyer's book: Handbook of PI and PID Controller the Engine tuning Rules, Imperial College Press, 2006. The PI and PID tuning methodology is based on procedures which have been worked out by Ziegler and Nichols (Ziegler J. G., Nichols N. B.: The optimum Setting the odds Automatic Controllers, ASME, Rochester, N.Y., 1942). There are two procedures: the first is called the frequency response method and the second-step response method.

The frequency method is based on the properties analysis of the closed-loop control system (error-actuated control system) being on the stability limit. The proportional P controller is used at the first stage of this tuning procedure. Its gain is increasing up to the achieve sustained oscillations of the controlled signal. Then the controller proportional gain and the oscillation period of closed loop system are assessed. These values are used to determine PI and PID controller settings.

The step response method is based on a rough estimation of the controlled system model parameters. The first order filter with dead time is the estimating model. The settings of PI or PID controllers working in the feedback control system are calculated on the basis of the estimated values.

The controller properties were calculated for the P controller. The replacement of the P controller with the PI or PID controllers changes the control system characteristics. It makes difficult to select right controller settings which assures proper work of control system. The first stages of the tuning procedures do not identify controlled system dynamics precisely. That is why the settings proposed by these procedures do not assure the proper transient waveform.

There are also known the controller tuning methods based on the frequency characteristics analysis (Y. Iino, T. Shigemasa: Control system and method for deterministic control parameters of plants, U.S. Pat. No. 5,172,312). Those methods require earlier determination of the frequency characteristic, which may be inconvenient and time-consuming.

The computer technology progress makes it possible to develop a numerical method of controller tuning parameters which are optimal in the sense of the selected criterion. The criterions may be formulated by use of known and frequently used analytical formulas such as the ITAE criterion (A. E. Awouda, R. B. Mamat: New PID tuning rule using ITAE criteria, IJE, 2010). Optimality criterion can also be formulated by equations which may be solved only by use of numerical optimization methods (R. Toscano: A Simple robust PI-PID controller design via numerical optimization approach, JPC, 2005). The exact knowledge of the controlled system dynamics is the prerequisite to get optimal controller parameters. That dynamics is often approximated by first order filter with dead time model. The main advantage of the model is a limited set of parameters while the disadvantage is excessively simplified controlled system dynamics, especially for incorrectly identified model parameters. The above mentioned tuning methods do not include the identification stage which makes them useless.

According to the invention, only the integral controller is added to the controlled system at the first stage of the PI or PID controller tuning procedure, which is the first order filter with dead time. It means that the proportional and differential parts of the PID controller are disconnected. This is the invention's distinctive feature. It is assumed that the proportional gain k of the controlled system in steady state is known. At the next stage, the integral controller gain kₗ is increasing to achieve sustained oscillation with constant period. When the closed-loop control system is on the stability limit, the ultimate controller gain k_{U} and the oscillation period T_{osc} are assessed. The formula:

$$T = \frac{\sqrt{{k}_{U}^{2} {k}^{2} - {ω}_{osc}^{2}}}{{ω}_{osc}^{2}}$$

where ω_{osc}=2π/T_{osc} allows to calculate the first order lag T and the θ=L/T=(arcctg(ω_{osc}T))/(ω_{osc}T) coefficient of the approximating model where the L is dead time. Formulas

kₒ=10^{-0.67+0.49/\sqrt{θ}}

τ=0.91+0.31·θ+0.0058·θ²

defines the controller model properties. The controller properties are calculated from

$${k}_{pN} = \frac{{k}_{o}}{k}$$

$${T}_{iN} = τ \cdot T$$

where k_{pN} is the proportional controller gain and the T_{iN} is integral controller time constant.

Only the integral controller is added to the controlled system at the first stage of the invented tuning procedure for the PID type controller, which is the first order filter with dead time (the proportional and the derivative PID controller parts are disconnected only the integral part is active). It is distinctive feature of this invention. It is assumed that the proportional gain of the controlled system in steady state is known, this is the k coefficient. Next, the gain of the integral controller kₗ is changed to get the system to the stability limit. Then the ultimate integral controller gain k_{U} and the oscillation period T_{osc} are assessed. The formula:

$$T = \frac{\sqrt{{k}_{U}^{2} {k}^{2} - {ω}_{osc}^{2}}}{{ω}_{osc}^{2}}$$

where ω_{osc}=2/90 /T_{osc} allows to calculate the first order lag T and the θ=L/T=(arcctg(ω_{osc}T))/(ω_{osc}T) coefficient of the approximating model where the L is dead time. The formulas

kₒ=10^{-0.79+0.81/}^{³}^{\sqrt{θ}}

τ=0.97+0.4·θ

δ=−0.16+0.48\sqrt{θ}

define the controller model properties. The controller parameters are calculated from

$${k}_{pN} = \frac{{k}_{o}}{k}$$

$${T}_{{}_{i} N} = τ \cdot T$$

$${T}_{dN} = δ \cdot T$$

where k_{pN} is the proportional controller gain, the T_{iN} is integral controller time constant and the T_{dN} is derivative controller time constant.

Assumptions to the invented tuning method are:
1. The proportional gain of the controlled system is known. It can be easily determined by the step response experiment.
2. The controlled system dynamics is acceptably approximated by the first order filter with dead time (Kupfmuller model):

$${G}_{ob} ( s ) = \frac{k {e}^{- sL}}{1 + sT}$$

where: k is the proportional gain, T is the first order lag and the L is dead time.

At the first stage of the invented procedure the controlled system is connected in series with the integral type controller with kₗ gain coefficient. Next, the integral controller gain is increased to get the closed-loop control system to the stability limit. At that point, the control system sustained oscillation period T_{osc} and the controller ultimate gain k_{U} are described and stored.

The system consists of the integral controller connected in series and the first order filter with dead time the first order filter time constant of the controlled system model is estimated using the formula:

$$T = \frac{\sqrt{{k}_{U}^{2} {k}^{2} - {ω}_{osc}^{2}}}{{ω}_{osc}^{2}}$$

$$where$$

$${ω}_{osc} = 2 π / {T}_{osc} .$$

The θ=L/T=(arcctg(ω_{osc}T))/(ω_{osc}T) coefficient, defined as the quotient of the first order lag T and the dead time L, is calculated from the phase shift angle of the approximating model of the open-loop control system.

The setting of the PI and PID type controllers models were calculated as optimal according to the ITAE criterion (integral of the product of time and the absolute control error of closed loop system).

The optimal setting of the PI and PID controllers were calculated as a function of θ coefficient. Introduction of the θ coefficient facilitates the calculation, because of the decreasing number of input variables. The time settings of the controllers are dimensionless and related to time constant of the control object first order filter T.

The optimal settings (according to the ITAE criterion) of the PID controller are approximated by the following formulas:

kₒ=10^{-0.79+0.81/}^{³}^{\sqrt{θ}}

τ=0.97+0.4·θ

δ=−0.16+0.48\sqrt{θ}

For the PI controller the optimal settings according to the ITAE criterion are approximated by formulas:

kₒ=10^{-0.67+0.49/\sqrt{θ}}

τ=0.91+0.31·θ+0.0058·θ²

Since the properties of the controller model are related to the coefficients of the controlled system model, the real controller settings have to be calculated by the following formulas:

$${k}_{pN} = \frac{{k}_{o}}{k}$$

$${T}_{iN} = τ \cdot T$$

$${T}_{dN} = δ \cdot T$$

where k_{pN} is the proportional controller gain, T_{iN} is integral controller time constant and T_{dN} is derivative controller time constant.

The subject of this invention is presented in the following six figures.

FIG. 1 shows the control system block diagram.

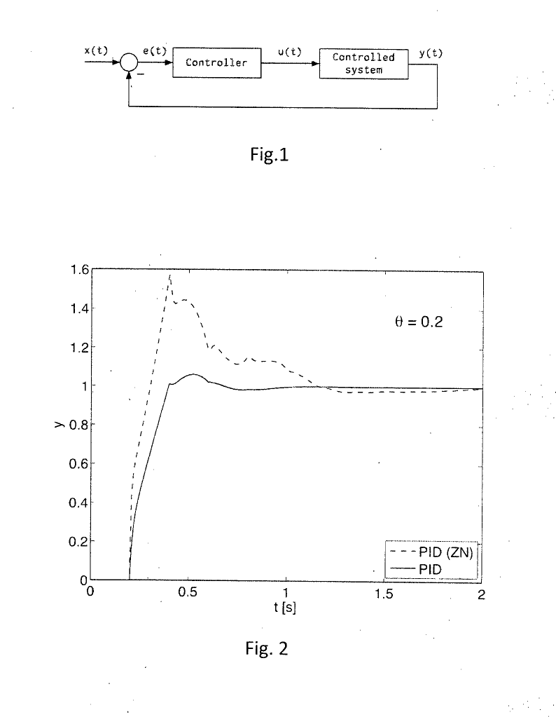

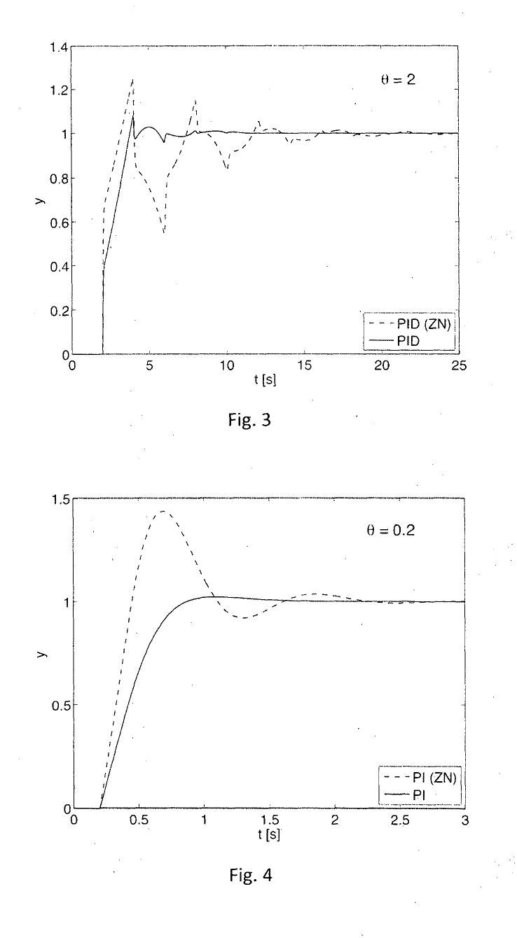

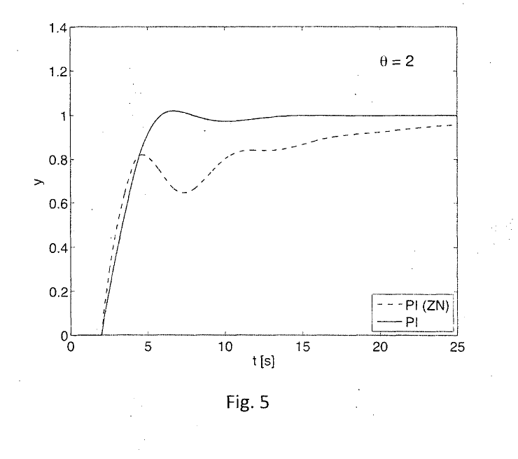

FIGS. 2 to 5 show the step responses of the closed-loop control system obtained for the invented and the Ziegler-Nichols methods. The gain of the controlled system is equal to 1. FIG. 2 shows the step responses of the system with PID controller and the θ=0.2. FIG. 3 shows step responses of the system with PID controller and the θ=2. FIG. 4 shows the step responses of the system with PI controller and the θ=0.2. FIG. 5 shows the step responses of the system with PI controller and the θ=2.

The PI controller settings are presented in the Table 1. The PID controller settings are shown in the Table 2.

TABLE 1
The PI controller Settings, according to ITAE

| Controlled system | Controller settings | | | |
|---|---|---|---|---|
| properties | according to the | | Standard Ziegler-Nichols | |
| (k = 1, T = 1) | invention | | controller settings | |
| θ | kₒ | τ | k_{rN} | T_{iN} |
| 0.2 | 2.664 | 0.972 | 3.826 | 0.620 |
| 2 | 0.4747 | 1.553 | 0.684 | 4.575 |

TABLE 2
The PID controller settings, according to ITAE

| Controlled | | | | | | |
|---|---|---|---|---|---|---|
| system | Controller settings | | | | | |
| properties | according | | | Standard Ziegler-Nichols | | |
| (k = 1, T = 1) | to the invention | | | settings | | |
| θ | kₒ | τ | δ | k_{rN} | T_{iN} | T_{dN} |
| 0.2 | 3.936 | 1.05 | 0.054 | 5.10 | 0.372 | 0.093 |
| 2 | 0.712 | 1.77 | 0.518 | 0.912 | 2.745 | 0.686 |

The invented method generates smaller overshoot and oscillation of the controlled value during the transient (FIG. 2 to FIG. 5). Additionally eliminates the adverse phenomenon of excessively damped of the controlled value for a bigger θ coefficient and the PI controller (FIG. 5).

1. The tuning methods of the PI controller parameters in the closed loop control system of the object, which the transfer function may be approximated as the first order filter with time constant T and dead time L, and known gain k, comprising the steps of:
(a) connecting in series the input of the controlled object with the output of the integral part of the controller, which the proportional part is disconnected, setting the lowest gain value and closing the control loop,
(b) increasing the controller gain up to the stability limit with stable oscillations of the controlled variable and describing the period of the oscillations T_{osc} and fixed value of the controller gain k_{U},
(c) calculating of the first order lag T of the controlled system model using the following formula
$$T = \frac{\sqrt{{k}_{U}^{2} {k}^{2} - {ω}_{osc}^{2}}}{{ω}_{osc}^{2}}$$
where ω_{osc}=2π/T_{osc} and the coefficient θ=(arcctg(ω_{osc}T))/(ω_{osc}T)=L/T where L is the controlled system model dead time,
(d) calculating the settings of the PI controller from the following formula and determine the physical settings of the real PI controller from the relations
$${k}_{pN} = \frac{{k}_{0}}{k}$$
$${T}_{iN} = τ \cdot T$$
where k_{pN} is the proportional controller gain and the T_{iN} is integral controller time constant.

2. The tuning methods of the PID controllers parameters in the closed loop control system of the object, which the transfer function may be approximated as the first order filter with time constant T and with dead time L, and known gain k, comprising the step of
(a) connecting in series the input of the controlled object with the output of the integral part of the controller, which the proportional and the differential parts are disconnected, setting the lowest gain value and closing the control loop,
(b) increasing the controller gain up to the stability limit with stable oscillations of the controlled variable and describing the period of the oscillations T_{osc} and fixed value of the controller gain k_{U},
(c) calculating of the first order lag T of the controlled system model using the following formula
$$T = \frac{\sqrt{{k}_{U}^{2} {k}^{2} - {ω}_{osc}^{2}}}{{ω}_{osc}^{2}}$$
where ω_{osc}=2π/T_{osc} and the coefficient θ=(arcctg(ω_{osc}T))/(ω_{osc}T)=L/T where L is the controlled system model dead time,
(d) calculating the settings of the PID controller from the following formula
Kₒ=10^{-0.79+0.81/}^{³}^{\sqrt{θ}}
τ=0.97+0.4·θ
δ=−0.16+0.48\sqrt{θ}
and determine the physical settings of real PI controller from the relations
$${k}_{pN} = \frac{{k}_{o}}{k}$$
$${T}_{iN} = τ \cdot T$$
$${T}_{dN} = δ \cdot T$$
where k_{pN} is the proportional controller gain and the T_{iN} is the integral controller time constant and the T_{dN} is derivative controller time constant.
